(19) United States
(12) Patent Application Publication
(10) Pub. No.: US 2026/0121480 A1
(43) Pub. Date: Apr. 30, 2026

(54) FLYWHEEL ASSEMBLY AND HOIST MECHANISM AND TIMING DEVICE FOR POWERING AN ELECTRIC GENERATOR

(71) Applicants: Clinton William Walker, III, Greenville, MS (US); Christopher William Walker, Birmingham, AL (US); Tyler Barrett Williams, Red Wing, MN (US)

(72) Inventors: Clinton William Walker, III, Greenville, MS (US); Christopher William Walker, Birmingham, AL (US); Tyler Barrett Williams, Red Wing, MN (US)

(21) Appl. No.: 19/045,286

(22) Filed: Feb. 4, 2025

Related U.S. Application Data
(63) Continuation-in-part of application No. 18/929,427, filed on Oct. 28, 2024, now abandoned.

(51) Int. Cl. H02K 7/02; F03G 3/08; H02K 7/108; H02K 7/116; H02K 7/18

(52) U.S. Cl. CPC H02K 7/02; F03G 3/08; H02K 7/108; H02K 7/116; H02K 7/1853

(57) ABSTRACT

A flywheel assembly and hoist mechanism for powering an electrical generator including a housing, a flywheel assembly positioned in the housing, a flywheel path defined for the flywheel assembly in the housing, and a hoist mechanism aligned with the flywheel path. The flywheel path is configured in such a configuration that the flywheel is returned to its point of origin with a hoist mechanism. The flywheel assembly positions at the top of the flywheel path and rotates along a downward path of the flywheel path. The flywheel assembly descends while rotating along the downward path. The rotational speed of the flywheel increases quadratically as it accelerates along the flywheel path and stores kinetic energy, which is then converted into electricity. The hoist mechanism receives the flywheel assembly and lifts the flywheel assembly back to the top of the flywheel path for continuous operation.

### BACKGROUND OF THE INVENTION

The present application is a continuation-in-part of U.S. Non-Provisional application Ser. No. 18/929,427, filed Oct. 28, 2024; all of which is incorporated herein in its entirety and referenced hereto.

### FIELD OF THE INVENTION

The present invention generally relates to flywheels and hoist mechanisms and load management systems. More specifically, the present invention relates to a flywheel assembly and hoist mechanism and load management systems utilizing gravitational force, computer regulated electrical/mechanical generators and hoist mechanism, quadratic acceleration, and the optimization of time for powering an electrical generator/alternator and/or storing electricity.

### DESCRIPTION OF THE PRIOR ART

Different techniques or methodologies are utilized to generate and store electricity. Some of the techniques include use of hydroelectric dams, burning of fossil fuels, such as coal, oil and natural gas, wind, solar, nuclear and tidal forces and the like. Each of the techniques of electricity generation possesses its own unique set of serious flaws and disadvantages. For example, hydroelectric dams are only available where large rivers have been dammed up and are extremely expensive to construct and maintain. The burning of fossil fuels causes pollution and climate change. Wind generation requires very large areas of open land or water and can only operate when the wind is favorable (not too high or too light). Wind energy is not available in most metropolitan locations. Solar can only be utilized during daylight hours and is not effective on cloudy days. Thus, solar is available, at best, only 10 hours a day. Like wind, solar energy requires large land or sea areas. Tidal energy is extremely limited geographically, hazardous as obstructions to navigation, extremely expensive, and unproven economically.

Likewise, different techniques and methodologies are and have been utilized to store electricity. Some of the techniques include the use of pumped hydroelectric, compressed air, flywheel energy storage systems (FESS; flywheels rotating horizontally, not vertically), chemical batteries, thermal energy storage, and gravitational energy storage systems (GESS) which simply use heavy weights lifted during periods of excess energy production and lowered when needed.

Traditionally, electrical power sources have been large and centrally located, exporting the electricity great distances to the end users. The large, centrally located power sources lend themselves to enemy attack, both physical and digital, as well as subject the end user to periodic outages due to natural disasters.

For more than 100 years now, man has been using gravity to generate electricity. Generating electricity through the use of gravity is accomplished by damming up rivers and permitting gravitational forces to accumulate in the form of the headwaters above the dam. The forces of gravity are then utilized in the form of water under high pressure due to the force of gravity stored in the weight of the water piled up behind the dam. In this scenario, the dam acts as an “accumulator” of static gravitational forces.

More recently, gravity has been used to store energy. These are comprised of weights lifted during times of high energy production and lowered during times when either energy production is poor, or additional energy is needed. In these systems, static gravitational forces (i.e. weight) are used to store energy kinetically. These are known as gravitational energy storage systems, or “GESS.”

With improvements in technology, flywheels have also been used as batteries or “accumulators” of kinetic energy to store and release electrical energy. These are known as flywheel energy storage systems “FESS.” These flywheels typically run horizontally, as opposed to vertically, and are powered by electrical motors. Moreover, the current flywheel storage systems do not utilize the advantages of quadratic acceleration due to gravity. As a result, flywheels have not been used as the initial “generator” or initial “accumulator” to produce the electricity.

To date, the dynamic properties of gravity (its effect on falling bodies which produces a quadratic acceleration on the falling body) have been underutilized.

It is desirable to utilize flywheels to act, in association with other collocated conventional energy sources, as initial or additional accumulators of gravitational forces of electricity to generate, store and/or enhance electrical energy and to utilize the quadratic acceleration forces unique to gravity to power and/or enhance electrical generators and/or alternators and/or batteries.

In addition, it is desirable to utilize flywheels to act, in association with other collocated conventional energy sources, as large batteries to decentralize the distribution of available electrical energy.

Therefore, there is a need in the art for a flywheel and hoist assembly system, decentralizing the distribution of available electrical energy utilizing gravity, and other collated energy sources, such as electricity from solar or wind or other forms of energy as the driving forces for both powering an electrical generator and/or enhancing or storing electricity. There is also a need for the optimization of time and electrical load utilized to operate such devices so as to improve energy efficiencies. Such a flywheel and hoist assembly and load and timing device could act in conjunction with other systems, such as wind, solar, coal, and others, and help generate and store electricity at all times, and at almost any geographic location.

### SUMMARY OF THE INVENTION

It is an object of the present invention to provide a flywheel assembly and hoist mechanism and load management system for partially powering an electrical generator and storing and enhancing periodic electricity needs and decentralizing the distribution of available electrical energy, that avoids the drawbacks of known techniques.

It is another object of the present invention to provide a flywheel assembly and hoist mechanism and load and timing device that acts as an initial accumulator of gravitational forces and/or to act as a periodic enhancer of electricity which utilizes the quadratic acceleration forces unique to gravity to power electrical generators and/or alternators.

It is another object of the present invention to provide a unique way of generating, storing and/or enhancing electricity generation from combined sources at all times in any geographical location and to avoid or reduce the use of fossil fuels, and decentralize the distribution of available electrical energy.

It is another object of the present invention to manipulate and optimize the electrical load and time used in cycling the device so as to improve energy efficiencies.

In order to achieve one or more objects here stated the present invention provides a flywheel/generator assembly and hoist mechanism for powering an electrical generator/alternator. The flywheel/generator assembly includes a flywheel(s) connecting an axle to small gears or sprockets, clutches, rack and/or ring gear assemblies, bearings, flywheels, generators or alternators with load management systems and stabilizing rods and combining these with a timed generator and a timed lifting or hoisting mechanism so that the process can be repeatable and energy efficiencies can be optimized. The combination of flywheels, the axle, the small gears or sprockets, the clutches, the bearings, the generators or alternators and stabilizing rods are collectively referred to as the “flywheel/generator assembly” or “flywheel assembly”. The path of the flywheel is restricted to a geometrically confined area by bearings, bearing races, and/or other support structures. This is referred to as the flywheel path. The diameter or circumference of the flywheel is larger than the small gears or sprockets. The small gears or sprockets are mounted to the axle by way of clutches which permit the gears to either engage and turn the axle or spin freely as needs require. The stabilizing rods connect to the outside stators of the generators and run through pivoting sleeves in the housing, or through the lifting motors themselves, or to fixed centerline axles, depending upon the particular configuration, so as to prevent the stators on the generators from spinning with the rest of the flywheel assembly, yet still permit the flywheel assembly to travel both vertically and horizontally or in a circular motion. The structural housing supports fixed rack and/or ring gear assemblies on each side of the support structure bordering the downward flywheel path which correspond with and engage with the small gears or sprockets on the flywheel assembly. The fixed racks and/or ring gear assemblies are permanently mounted along the downward flywheel path so as to create and maintain rotational motion of the flywheel assembly so that it always spins in the same direction. The axle-mounted generators or alternators are equipped with computer regulated load management systems so as to manage both the speed of rotation and linear speed of the flywheel assembly, as well as the amount of electricity generated from the system. The speed of the flywheel's rotation as well as its linear motion are governed by the varying loads placed on the generator. In addition, the flywheel path includes a path that always returns the flywheel to its original point of origin. Furthermore, the flywheel assembly and hoist mechanism is equipped with a timed lifting or hoisting mechanism which, combined with other different collocated energy sources, return the flywheel/generator assembly to the top of the flywheel assembly and hoist mechanism, or point of origin.

The invention is started by positioning the flywheel assembly near the top of the flywheel assembly path/flywheel path (point of origin) with the small gears or sprockets in engagement with the rack and/or ring gear assemblies along the downward flywheel path. At this point the clutches are engaged so as to rotate the entire flywheel assembly in synchronization with the rotations of the small gear. The force of gravity causes the entire flywheel assembly to travel down the rack and/or ring gear assemblies along the downward path. As the flywheel/generator assembly descends, the small gears or sprockets, engaged by the clutches, engage with the fixed rack and/or ring gear assemblies. The rack and/or ring gear assemblies, which are fixed in place and cannot move, cause the gears or sprockets, which are firmly affixed to the flywheel assembly axle by way of the engaged clutches, to rotate. Because the flywheel assembly is permitted to spin freely, floating within the bearings connecting the flywheel assembly to the bearing races in the housing, or to the centerline axles if configured in a circular embodiment, the entire flywheel assembly, including the flywheel itself, and the rotor inside the generator, rotate at the same speed as the gears or sprockets. The stators located on the outside of the axle-mounted generators are prevented from rotating with the rest of the flywheel assembly by the stabilizing rods which are connected on one end to the stators, and the other end passes through fixed pivoting sleeves in the housing or to the lifting motors themselves or to rotating discs affixed to the lifting motors if configured in a circular design, thus permitting the flywheel assembly to rotate freely and to also move both vertically and horizontally. As a result of the small diameter of the gears or sprockets on the flywheel assembly, the flywheel assembly requires multiple rotations to reach the bottom of the flywheel path. As the flywheel assembly travels down the path it continues to pick up speed with each rotation, both linearly and rotationally (at a quadratic rate) storing energy in the flywheel as it goes.

As the flywheel assembly begins its travel down the flywheel path, no load is initially placed on the generator, permitting the flywheel assembly to spin freely, increasing its speed (at a quadratic rate) both rotationally and linearly as it travels down the flywheel path. At some point down the flywheel path, a load is placed on the generator. The load on the generator is calculated so as to extract the maximum kinetic energy stored in the flywheel assembly and to slowly bring it to a stop, both rationally and linearly, by the time it reaches the bottom of the flywheel path. At this time the clutches are disengaged permitting the flywheel assembly to continue rotating at a different rate and/or direction than the small gears or sprockets, so that the flywheel assembly can be hoisted back into its position without misalignment.

The electricity generated by the flywheel generator is then transmitted up the cable to the top of the flywheel assembly and hoist mechanism (or to some other location depending upon the configuration) and is either used to assist in the electrical hoist lifting of the flywheel assembly up to the top of the flywheel path, or it is diverted to storage into another battery or used. Meanwhile, auxiliary electrical energy from an external electrical source, such as wind or solar or gas or coal, or some other source (battery) is used to further power the electrical hoist which pulls the flywheel assembly back to the top of the flywheel assembly and hoist mechanism.

After the flywheel assembly has come to a complete stop, with the clutches disengaged, the electrical hoist is used to move the flywheel assembly back into its original position so that the clutches can once again be re-engaged with the gears or sprockets and the rack and/or ring gear assemblies are once again engaged. The speed of the lift is regulated by a computer-regulated timing device so as to maximize the efficiency of the process. The process is then repeated.

In one advantageous feature of the present invention, the flywheel is used as the initial accumulator of kinetic energy to produce the electricity. Further, the flywheel is utilized as an accumulator of gravitational forces, and the quadratic acceleration forces unique to gravity to power electrical generators and/or alternators. In addition, additional assistance, if needed, is used from an alternative power source which could be a conventional power source, such as a battery, or alternative power source such as wind or solar. Thus, the flywheel assembly and hoist mechanism can be used in conjunction with another power source to either provide additional power when needed, or act as a battery storing electricity kinetically in the rotating flywheel, or to act as a periodic enhancer of electricity. Since gravity is used as the driving force for the flywheel, the flywheel assembly can be used at all times and in any geographical location. In addition, it is not hazardous to the environment, and might not require the purchase of any fuel to run, depending upon its alternate fuel source.

In the disclosed invention, the action of the rotating flywheel, capturing the force of gravity kinetically, is combined with collocated other energy sources (e.g., conventional sources such as coal-powered or gas-powered, or other green sources, such as solar or wind), as needed, to increase energy output from any system, and/or to store energy.

Furthermore, linking the flywheel/generator and hoist system with another energy source, such as solar or wind or even conventional energy sources, could substantially enhance or enable additional energy production because of collocation and combination benefits and greater power generation potential than other solo renewable technologies. Such collocation and combination of sources could also create significant reductions in the overall costs to extract as much energy as possible from any singular renewable or non-renewable source.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

FIG. 1 is a schematic diagram of a flywheel/generator assembly (removed from a flywheel assembly and hoist mechanism or structure and hoist assembly), in accordance with one embodiment of the present invention.

FIG. 2 is a schematic diagram (side view) of the flywheel assembly and hoist mechanism, including a movable flywheel/generator assembly inside a housing with the flywheel/generator assembly traveling down a flywheel path, in accordance with one embodiment (triangular configuration) of the present invention.

FIG. 3 is a schematic diagram (top view) of the flywheel assembly and hoist mechanism, including a movable flywheel/generator assembly inside the housing with the flywheel/generator assembly traveling down the flywheel path, in accordance with one embodiment (triangular configuration) of the present invention.

FIG. 4 is a schematic diagram (side view) of the flywheel assembly and hoist mechanism, including a movable flywheel/generator assembly inside a housing with the flywheel/generator assembly traveling down a flywheel path, in accordance with another embodiment of the present invention (stacked triangular configuration).

FIG. 5 is a schematic diagram (side view) of the flywheel assembly and hoist mechanism, including a movable flywheel/generator assembly inside a housing with the flywheel/generator assembly traveling down a flywheel path, in accordance with another embodiment (straight shaft design) of the present invention.

FIG. 6 is a schematic diagram (top view) of the flywheel assembly and hoist mechanism, including a movable flywheel/generator assembly inside a housing with the flywheel/generator assembly traveling down a flywheel path, in accordance with another embodiment (straight shaft design) of the present invention.

FIG. 7 is a schematic diagram (front view) of the flywheel assembly and hoist mechanism, including a movable flywheel/generator assembly inside a housing with the flywheel/generator assembly traveling down a flywheel path, in accordance with another embodiment (straight shaft design) of the present invention.

FIG. 8 is a schematic diagram (side view) of the flywheel assembly and hoist mechanism, including movable flywheel/generator assembly inside a housing with the flywheel/generator assembly at the bottom of the flywheel path, in accordance with another embodiment (circular configuration) of the present invention.

FIG. 9 is a blowup of a side view of the flywheel assembly and part of the hoist mechanism, showing the flywheel assembly modified for use in accordance with another embodiment (circular configuration) of the present invention.

FIG. 10 is a blowup of the one-way bearings and one-way clutches in accordance with another embodiment (circular configuration) of the present invention.

FIG. 11 is a set of schematic diagrams (front view) of the flywheel assembly and hoist mechanism, including movable flywheel/generator assembly inside a housing with the flywheel/generator assembly at different positions along the flywheel path during the operation of the invention, in accordance with another embodiment (circular configuration) of the present invention.

### DETAILED DESCRIPTION OF THE PREFERRED EMBODIMENTS

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed flywheel assembly and hoist mechanism. However, it will be apparent to those skilled in the art that the presently disclosed invention may be practiced without these specific details. In some instances, well-known structures and devices are shown in functional or conceptual diagram form in order to avoid obscuring the concepts of the presently disclosed flywheel assembly and hoist mechanism.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a flywheel assembly and hoist mechanism, it is to be further understood that numerous changes may arise in the details of the embodiments of the flywheel assembly and hoist mechanism. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

It should be understood that the present invention describes a flywheel/generator and hoist assembly for powering an electrical generator. The flywheel/generator and hoist assembly include a flywheel, connecting an axle and clutches and bearings and small gears or sprockets, a generator and stabilizing rods. Here, the flywheels, the generator with load management system and stabilizing rods, the small gears or sprockets, the clutches and the bearings are connected via an axle. The path of the flywheel/generator assembly is restricted to a geometrically confined area and the fixed rack and/or ring gear assemblies create and maintain rotational motion of the flywheel/generator assembly so that it always spins in the same direction. In the diagrams depicted, the rack and ring gear assemblies are positioned along the downward path of the flywheel. On the downward path of the flywheel/generator assembly the small gears or sprockets, once engaged by the clutches, engage with the fixed rack and/or ring gear assemblies, causing the flywheel/generator assembly to rotate. The stabilizing rods, connected on one end to the stators on the generators, pass through pivoting sleeves that are fixed in place in the housing, or through the lifting motors themselves, or connected to some other fixed structure thus permitting the flywheel assembly to both rotate and travel vertically and horizontally, yet preventing the stators from rotating with the rest of the flywheel assembly. During this trip down the flywheel path, initially no load is placed on the generator, so the flywheel/generator assembly is permitted to rotate freely. On the downward path, the flywheel/generator assembly, being propelled down the flywheel path by the force of gravity, begins rotating as well as traveling linearly. As the flywheel/generator assembly travels down the flywheel path, it picks up speed, both translationally and rotationally, with each rotation, at a quadratic rate, storing kinetic energy in the flywheel as it goes. At some point down the flywheel path, a load is placed on the generator. The load on the generator is calculated so as to extract the maximum kinetic energy stored in the flywheel assembly slowly bringing it to a stop, both rationally and linearly, by the time it reaches the bottom of the flywheel path.

Electricity generated by the flywheel generator is transmitted to the top of the flywheel assembly and hoist mechanism (or to some other location). That electricity is either used to assist in the electrical hoist lifting the flywheel assembly back to the top to its point of origin, or it is diverted to storage into another battery, or for some other use.

At the bottom of the flywheel assembly path, the clutches are disengaged, and the flywheel/generator assembly is captured in the hoist assembly catch cradle.

After the flywheel/generator assembly has come to a stop and has been captured by the hoist assembly catch cradle, auxiliary electrical energy from an external source, such as wind or solar, or some other conventional energy source, is used to further power the electrical hoist using the same cable or the stabilizing rods, depending upon the embodiment, to now lift the flywheel assembly back up to the top of the flywheel assembly and hoist mechanism. The lift is regulated by a timing device so as to maximize the energy efficiencies of the system. At this point, the hoist is used to position the flywheel assembly at the top of the flywheel path and the clutches are once again engaged. The process is then repeated.

### The Triangle Shaped Embodiment

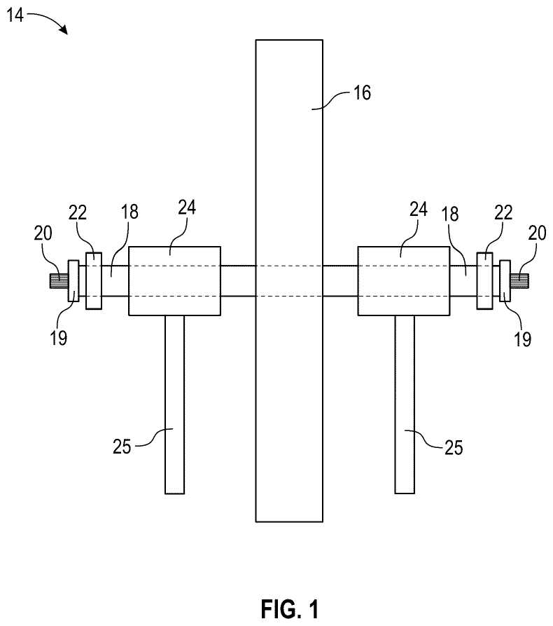

Various features and embodiments of the flywheel assembly for powering an electrical generator in a triangle shaped configuration are explained in conjunction with the description of FIG. 1 through FIG. 3.

FIG. 1 shows a schematic diagram of a flywheel/generator assembly 14 (removed from the housing 12), in accordance with one exemplary embodiment of the present invention (a triangle shaped configuration). Flywheel/generator assembly 14 includes flywheel 16, an axle 18, clutches 19, small gears or sprockets 20, bearings 22, axle-mounted generators with load management systems or electric generators or simply generator 24, and stabilizing rods 25 connected to the stators on the generators 24. In other words, flywheel 16, an axle 18, clutches 19, small gears or sprockets 20, bearings 22, axle-mounted computer-controlled generators 24, and stabilizing rods 25 form flywheel/generator assembly 14. For simplicity, flywheel/generator assembly 14 may also be referred as flywheel assembly 14 hereinafter.

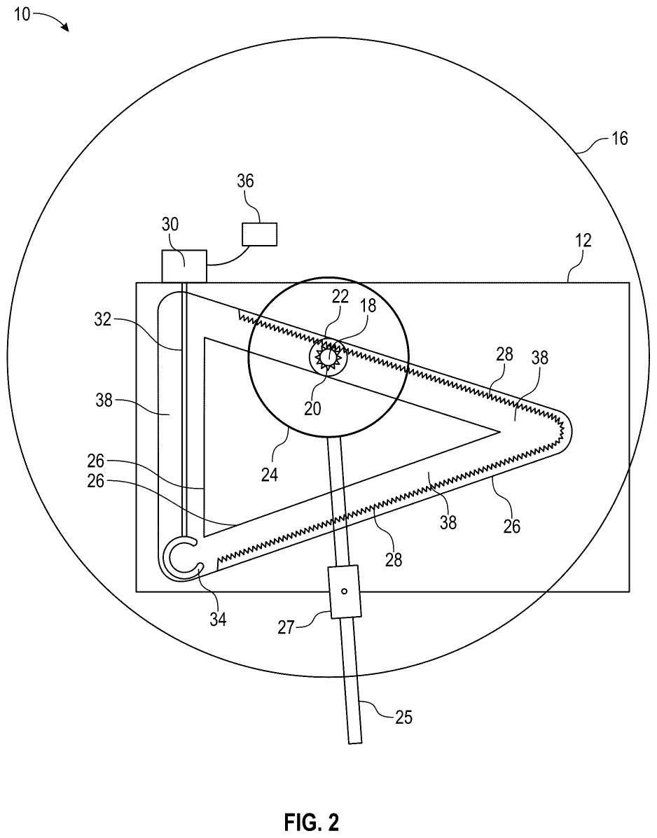

FIG. 2 shows a side view schematic diagram of flywheel assembly and hoist mechanism 10, demonstrating flywheel/generator assembly 14 inside a housing 12 on the downward path, in accordance with one embodiment of the present invention (the triangle shaped configuration). Note: clutches 19, are not shown in FIG. 2

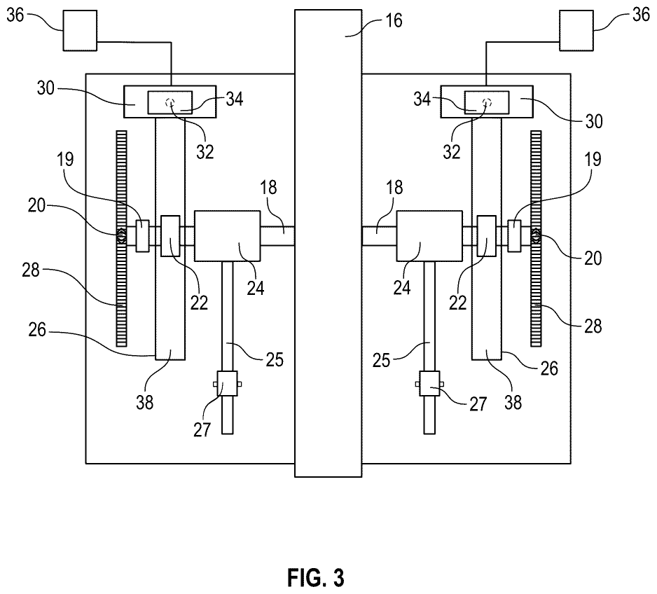

FIG. 3 shows a top-down view of flywheel assembly and hoist mechanism 10, demonstrating flywheel/generator assembly 14 inside the housing 12 on the downward path, in accordance with one embodiment of the present invention (the triangle shaped configuration). In other words, FIG. 3 shows flywheel 16, axle 18, clutches 19, gears or sprockets 20, and bearings 22 and axle-mounted computer-controlled generators 24 and stabilizing rods 25. FIG. 3 also shows bearing races 26 mounted in the housing 12 as well as rack and ring gears 28 also mounted in the housing 12. FIG. 3 also shows electric motors 30, catch cradles 34 and lifting cables 32 as well as batteries or other energy sources 36.

Referring to FIG. 2 and FIG. 3, flywheel assembly and hoist mechanism 10 includes flywheel 16, axle 18, clutches 19 (not shown in FIG. 2), gears or sprockets 20, bearings 22, axle-mounted computer-controlled generators 24, stabilizing rods 25, bearing races 26, pivoting sleeves fixed in the base of the housing 27, rack and ring gear assemblies 28, electric motors 30, cables 32, hoist catch cradles (hoist mechanism) 34, and a battery or other energy source 36.

As can be seen in FIG. 1, FIG. 2, and FIG. 3, axle 18 connects to flywheel 16. Bearings 22 permit the flywheel assembly 14 to rotate within and move linearly and vertically within the housing 12. Gears or sprockets 20 mount at the end of axle 18 and are engaged and disengaged from the rest of the flywheel assembly 14 through the operation of clutches 19. In one example, axle-mounted computer-controlled generators 24 connects to axle 18, while the stators of the generators are prevented from rotating by the stabilizing rods 25 which pass through the fixed pivot sleeves 27 in the housing. Bearings 22 present bearing races 26. Rack and ring gear assemblies 28 are positioned along the downward path of flywheel path 38. FIG. 2 shows flywheel path 38 in a triangle shaped configuration in alignment with bearing races 26. Further, housing 12 includes fixed pivot sleeves 27, through which the stabilizing rods 25 can pass, electric motors 30 i.e., electric motors at the top, as can be seen from FIG. 2 and FIG. 3. Electric motors 30 connect to a battery or batteries or any other energy source 36. Further, electric motors 30 connect to hoist catch cradles 34 via cables 32.

Now referring to FIG. 2, the operation of the flywheel assembly and hoist mechanism 10 in a triangle shaped configuration is described. In FIG. 2, flywheel assembly and hoist mechanism 10 is started with the flywheel/generator assembly 14 raised to the top of the flywheel/generator assembly path i.e., flywheel path 38. It should be understood that flywheel path 38 is defined by bearing races 26 with clutches 19 engaged, and axle-mounted computer-controlled generator 24 disengaged and not pulling any load. Flywheel path 38 begins at an approximate 20 degrees down angle from horizontal. At this point, flywheel/generator assembly 14 is released and gravity begins pulling the mass of flywheel/generator assembly 14 down flywheel path 38. Immediately, gears or sprockets 20 which are engaged with the flywheel/generator assembly axle 18 by clutches 19, engage with rack and/or ring gear assemblies 28 which are rigidly affixed to housing 12. Since rack and ring gear assemblies 28 are fixed in place and cannot move, and flywheel/generator assembly 14 floats within its bearings 22, the entire flywheel/generator assembly 14, except the stators on the outside of the generator 24 which are prevented from rotating by the stabilizing rods 25, begins to rotate as it descends. As flywheel/generator assembly 14 continues its descent down flywheel path 38, due to the quadratic nature of gravity, flywheel/generator assembly 14 increases in speed, quadratically, both linearly and rotationally.

Since flywheel path 38 (in this example) is designed in the shape of a triangle laid on its side with the longest legs at approximately 20 degrees down angle from horizontal, and the shortest leg pointing vertically, the distance traveled linearly by the flywheel/generator assembly to get to the bottom is approximately 3 times longer than the distance it must travel to get back to the top.

At some point down flywheel path 38, a load is placed on axle-mounted computer-controlled generator 24. The load on axle-mounted computer-controlled generator 24 is calculated so as to extract the maximum kinetic energy stored in flywheel/generator assembly 14 slowly bringing it to a stop, both rotationally and linearly, by the time it reaches the bottom of the flywheel path 38.

Once flywheel/generator assembly 14 reaches the bottom of flywheel path 38, clutches 19 are disengaged, and axle 18 of flywheel/generator assembly 14 is captured by catch cradles 34. At that time, electric motors 30 use the electricity generated by flywheel/generator assembly 14 and a collocated additional energy source 36 to lift flywheel/generator assembly 14 back to top of the flywheel path 38 using cables 32 connecting each catch cradle 34 to the corresponding electric motor/winch 30. The lift is timed so as to maximize efficiency. Thereafter, the process is repeated.

By way of example and to demonstrate some of the advantages of the disclosed invention in the triangle shaped configuration, if we assume that the flywheel path is in a triangular form, with the vertical leg of the triangle being 1 m in length from bottom to top, and the top side of the triangle lies at an approximate 20° downslope from horizontal for a distance of 1.5 m and the bottom leg of the triangle also being at a down slope for a distance of 1.5 meters back to the bottom of the vertical leg of the triangular-shaped flywheel path; and if we further assume that the small gear or sprocket has a diameter of 3 cm; and we further assume that the flywheel is designed in an efficient form with the majority of the mass on the outside edge of the flywheel and the flywheel has a diameter of 2.5 meters, with a mass of the entire flywheel assembly 14 of 500 kg, then we can mathematically determine the potential energy that can be produced, lost and/or stored by one cycling of the invention as follows:

To find how many rotations the small gear will make to travel 3 meters, we can follow these steps:

### I. Calculate how Many Rotations the Flywheel Assembly Will Make to Get to the Bottom Of the Flywheel Path

Since the teeth of the small gear or sprocket are engaged with the teeth on the rack or ring gear, and the flywheel is not connected to anything except the axle at its center, the number of rotations the flywheel assembly will take to get to the end of the flywheel path is governed by the circumference of the small gear or sprocket which are engaged with the teeth of the rack or ring gear.

### Step 1: Calculate the Circumference of the Small Gear or Sprocket.

The circumference of the small gear or sprocket is given by the formula:

$$C = π D$$

Where D is the diameter of the small gear or sprocket. Since the diameter of the small gear or sprocket is 3 cm, and x is 3.1416

$$C = 3.1416 \times 3 cm$$

$$3.1416 \times 3 cm = 9.4248 \times 3 cm$$

So, the circumference of the small gear or sprocket is approximately 9.42 centimeters.

### Step 2: Convert the Distance to Centimeters

$$3 meters = 300 centimeters .$$

### Step 3: Find the Number of Rotations

To find the number of rotations, divide the total distance the gear travels (in centimeters) by the circumference of the gear.

$$Number of rotations = 300 cm / 9.42 cm = 31.85$$

Final Answer to Question No. I:
The flywheel assembly as it travels down the 3-meter long flywheel path, from the top of the path to the bottom of the path, will rotate approximately 31.85 times, always in the same direction, and end at the bottom of the 3 meter run, the flywheel assembly will be 1 meter below where it started from. This calculation tells us that both the small gear, and the much larger flywheel, both of which are firmly attached to each other by the axle, will make 31.85 rotations to make the 3-meter trip down the flywheel path.
   II. How many rotations will the flywheel assembly make if permitted to rotate freely for about 85% of the distance down the top leg of the flywheel path (about 42.5% of the total downward path) before a load is put on the generators to try and bring it to a stop before it reaches the bottom?
In order to efficiently utilize the device, the flywheel assembly must be permitted to rotate freely for some distance so as to take advantage of the principals unique to gravity. By way of example, if we were to assume that we could permit the flywheel assembly to freely rotate as it rolled down the top leg of the flywheel path for a distance of approximately 85 percent of the top leg, a distance of 127.5 cm (85% of 150 cm=127.5 cm) (approximately 42.5% of the entire downward path) before placing a load on the generators, then we could see how much kinetic energy had been stored in the flywheel at that particular point in time, that could then be harvested by the generators for the remaining 22.5 cm of the top leg and the entire 150 cm of the bottom leg of the flywheel path.
The first step in this process is to determine how many rotations the flywheel assembly will make by the time it has traveled 127.5 cm. Since the small gear or sprocket teeth are engaged with the rack or ring gears and the flywheel is not connected to anything except the axle at its center, the number of rotations is governed by the diameter of the small gear or sprocket, not by the diameter of the flywheel.
To determine how many rotations a small gear or sprocket with a diameter of 3 cm will make to travel 127.5 cm, we follow these steps:

### Step 1: Calculate the Circumference of the Small Gear or Sprocket

$$C = 3.1416 \times 3 cm$$

$$3.1416 \times 3 cm = 9.4248 cm$$

### Step 2: Calculate the Number of Rotations Needed to Travel 127.5 cm.

$$Number of rotations = total distance divided by the circumference of the small gear$$

$$Number of rotations = 127.5 / 9.42 = 13.53$$

Final Answer to Question No. II:
The flywheel assembly will make approximately 13.53 rotations to travel 127.5 cm down the flywheel path.
   III. How much kinetic energy will be generated by the flywheel with a mass of the flywheel assembly of 500 kg and a flywheel diameter of 2.5 m rolling down a 20° slope, without slipping, for a total of 13.53 rotations?
To determine the energy generated by the flywheel rolling down a 20° slope without slipping, we need to take into account both the translational and rotational kinetic energy of the flywheel, as it is rolling (not sliding). When a rolling object moves without slipping, its motion is a combination of both translational (linear) and rotational kinetic energy.

### Given:

Mass of the flywheel assembly, m=500 kg.
Diameter of the flywheel, D=2.5 m, so the radius R=D/2=1.25 m
Slope angle, θ=20°
Rotations down the slope, N=13.53
· Acceleration due to gravity, g=9.81 m/s²

### Step 1. Distance Traveled by the Flywheel:

Each rotation of the flywheel corresponds to a distance equal to the circumference of the flywheel:

$$Circumference = 2 π R = 2 π \times 1.25 = 7.85 m$$

The total distance rolled for 13.53 rotations is:

$$Total Distance = N \times Circumference = 13.53 \times 7.85 = 106.11 m$$

### Step 2. Height Change:

The height change, h, from the slope can be determined using the angle θ and the distance traveled along the slope:

$$h = Total distance \times sin ( θ )$$

$$h = 106.11 \times sin ( 20 ° ) = 106.11 \times 0.342 = 36.28 m$$

$$h = 36.28 m$$

### Step 3. Potential Energy Lost:

The total gravitational potential energy lost as the flywheel moves down the slope is:

$$P E = mgh$$

$$PE = 500 kg \times 9.81 m / {s}^{2} \times 36.28 m$$

$$PE = 500 \times 9.81 \times 36.28 = 177 , 976 J$$

### Step 4. Energy Distribution:

For an object rolling without slipping, the total energy is divided into two components:
   Translational kinetic energy (Ktrans)
   Rotational kinetic energy (Krot)
The total kinetic energy is the sum of these two components:

$$Ktotal = Ktrans + Krot$$

Final Answer to Question No. III:
The energy generated by the flywheel assembly 14 as it rolls down the 20° slope for a total of 13.53 rotations is equal to the total potential energy lost, which is approximately 177,976 Joules (J). This energy is split between the translational and rotational kinetic energy as the flywheel moves down the slope.
   IV. How Long do the Generators have, Once a Load is Placed on them, to Bring the Rotating Flywheel Assembly to a Stop?
The Generators now have 18.33 rotations of the flywheel assembly (31.85 rotations for the entire downward flywheel path, minus13.52 rotations already traveled by the flywheel assembly before a load was placed on the generators) within which to harvest, electronically, the kinetic energy amassed in the flywheel assembly and bring it to stop. This rate will be governed by the size and capacity of the generators, and the rate at which they are permitted to bleed off energy.
   V. How Much Energy Will be Needed to Lift the Flywheel Assembly Back to the Top Of the Flywheel Path where it Started.
At this point in the process, the kinetic energy has been harvested by the generators, and the flywheel assembly has been brought to a stop at the bottom of the flywheel path. The question then becomes, “How much energy will be needed to lift the entire flywheel assembly back to the top of the flywheel path where the process can be repeated?” The difference between the two will demonstrate how much energy has been lost, stored or generated in the process.
Since the lift is a vertical dead lift, neither the diameter of the flywheel nor the diameter of the small gear or sprocket are relevant, only the mass of the flywheel assembly. So, the question is how much energy is needed to lift 500 kg 1 meter.
To calculate the energy needed to lift a 500 kg object by 1 meter, use the formula for Work:

$$W = F \times d$$

Where:
   W is the work done (in Joules).
   F is the force required to lift the mass (in Newtons)
   d is the distance over which the force is applied (in meters)

### Step by Step Calculation:

$$F = m \times g$$

Where:
   m=500 kg is the mass
   g=9.81 m/s² is the acceleration due to gravity

$$F = 500 kg \times 9.81 m / {s}^{2} \times 4905 N$$

Now, using the formula for work:

$$W = F \times d = 4905 N \times 1 m = 4905 J$$

Final to Question No. V.
The energy required to lift a 500 kg object by 1 meter is 4,905 joules (J).

### VI. The Net Result

Potential Energy generated by flywheel assembly=177,976 J Minus the energy required to lift flywheel back to the top=4,905 J 177,976 J-4,905 J=173,071 J
In this example, the mathematical calculations demonstrate that in one cycling of the present invention in the assumed configuration, a net energy gain of 173,071 joules of energy are produced.
Different types of electrical generators (hydroelectric, nuclear, wind, solar, etc.) have different conversion rates, with hydroelectric being high [85%-95%] and wind turbines being low [35%-45%]). In all likelihood, due to the direct conversion of the potential energy from the mechanical energy of the flywheel into electrical energy, the conversion rate will be 90% or greater.
In any event, should the amount of energy needed to raise the flywheel assembly 1 meter back to its original starting position be more than generated through a cycle, the collocated alternative or conventional energy source can be utilized to effectuate or complete the lift.

### The Zig-Zag Embodiment (Stacked Triangles)

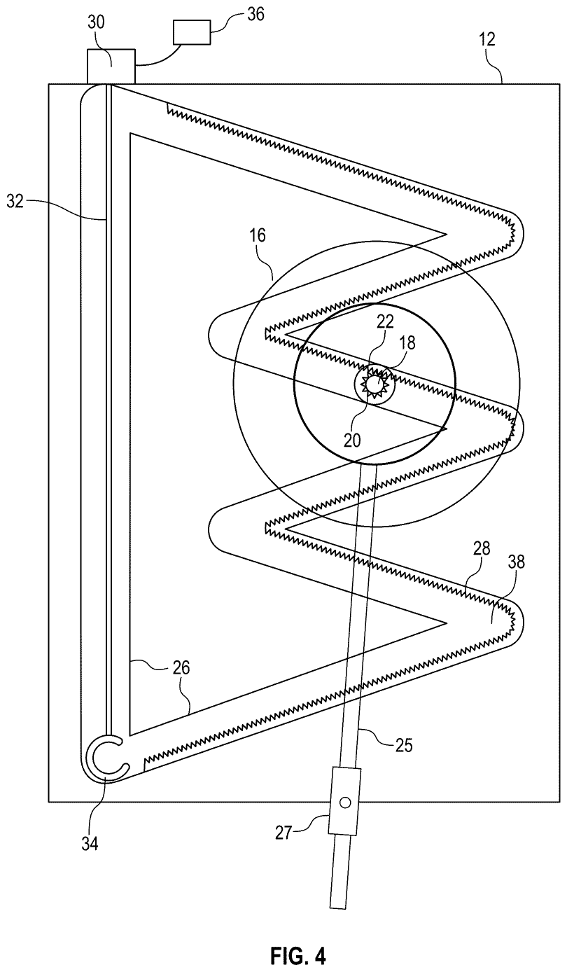

Referring to FIG. 4, a side view schematic diagram of flywheel assembly and hoist mechanism 10, demonstrating flywheel/generator assembly 14 inside a housing 12 in a zig-zag pattern on the downward path is shown, in accordance with another embodiment of the present invention. In FIG. 4, housing 12, flywheel 16, axle 18, gears or sprockets 20, bearings 22, bearing races 26, electric motors 30, cables 32, catch cradles 34, collocated additional energy source (battery) 36, flywheel path 38,-axle-mounted computer-controlled generators 24, stabilizing rods 25 and fixed pivot sleeves 27 are shown. FIG. 4 demonstrates that flywheel path 38 can be manipulated into various geometric forms (not limited to a triangle form as shown in FIG. 2) so as to fit within and maximize the available space. Here, flywheel path 38 is provided in an elongated zig-zag pattern going back and forth running both the length/width and the height of housing 12. Catch cradles 34 position at the bottom of housing 12, and connect to electric motors 30 positioned at the top of housing 12 via cables 32 (clutches 19 are not shown in FIG. 4). For instance, if the design of flywheel assembly and hoist mechanism 10 needs to be implemented in a ten story building (like an old abandoned factory buildings in a deserted portion of a large city), then the design could be in the form of an elongated zig-zag pattern (flywheel path 38) going back and forth running both the length of the building as well as the height of the building (as illustrated in FIG. 4), returning to catch cradle 34 at the bottom floor. Flywheel/generator assembly 14 could be lifted during the daytime using solar energy and released at dusk to run all night powering nighttime needs.

the same mathematical calculations that are applicable to the triangular shaped embodiment are applicable to the zig-zag (stacked triangles) embodiment.

### Straight Shaft Embodiment

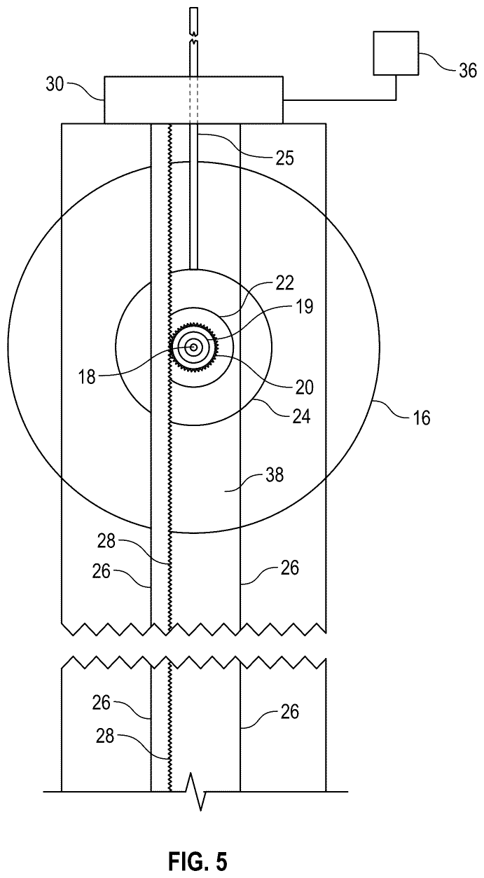

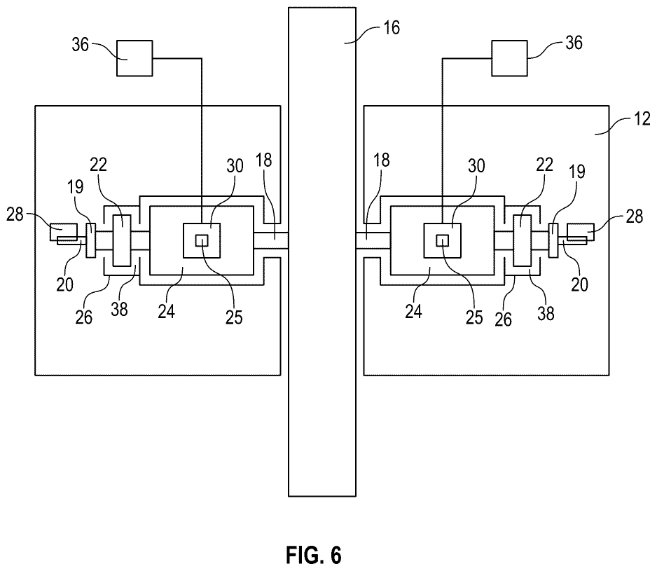

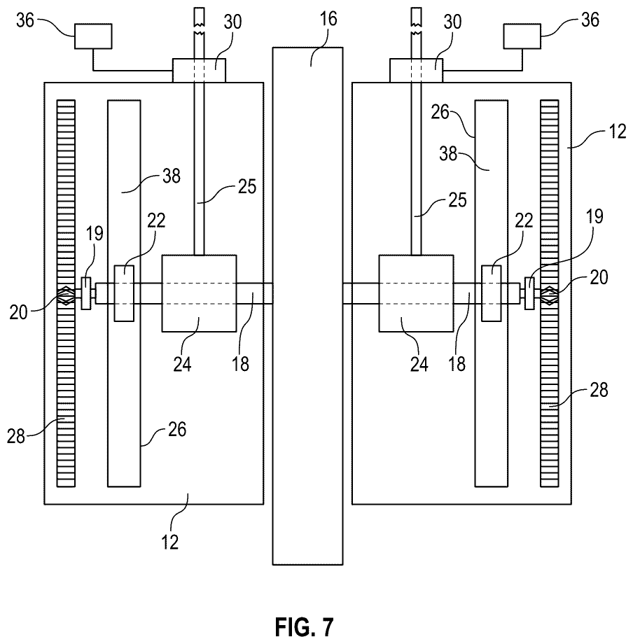

Now referring to FIG. 5, FIG. 6, and FIG. 7, the operation of the flywheel assembly and hoist mechanism 10 in another configuration (straight shaft) is described. In FIG. 5, FIG. 6 and FIG. 7, flywheel assembly and hoist mechanism 10 is started with the flywheel/generator assembly 14 raised to the top of the flywheel/generator assembly path i.e., flywheel path 38. It should be understood that flywheel path 38 is defined by bearing races 26 with clutches 19 engaged, and axle-mounted computer-controlled generator 24 disengaged and not pulling any load. Since this configuration is in a straight shaft, flywheel path 38 begins at the top and extends either straight downward at a 90-degree angle, or at some lesser angle from horizontal. At this point, flywheel/generator assembly 14 is released and gravity begins pulling the mass of flywheel/generator assembly 14 down flywheel path 38. Immediately, gears or sprockets 20 which are engaged with the flywheel/generator assembly axle 18 by clutches 19, engage with rack assemblies 28 which are rigidly affixed to housing 12. Since rack gear assemblies 28 are fixed in place and cannot move, and flywheel/generator assembly 14 floats within its bearings 22, the entire flywheel/generator assembly 14, except the stators on the outside of the generator 24 which are prevented from rotating by the stabilizing rods 25, begins to rotate as it descends. As flywheel/generator assembly 14 continues its descent down flywheel path 38, due to the quadratic nature of gravity, flywheel/generator assembly 14 increases in speed, quadratically, both linearly and rotationally.

In this straight shaft configuration, the stabilizing rods 25 pass through the electric motors 30 at the top of the housing 12 and are geared so that they also serve a dual purpose to both stabilize the stators of the generators 24 and to lift the entire flywheel assembly 14 once it comes to a stop, as the cables 32 do in the triangular configuration.

Since flywheel path 38 (in this example) is designed in the shape of a straight shaft, the linear distance traveled by the flywheel/generator assembly to get to the bottom is exactly the same distance it must travel to get back to the top.

At some point down flywheel path 38, a load is placed on axle-mounted computer-controlled generator 24. The load on axle-mounted computer-controlled generator 24 is calculated so as to extract the maximum kinetic energy stored in flywheel/generator assembly 14 slowly bringing it to a stop, both rotationally and linearly, by the time it reaches the bottom of the flywheel path 38, i.e., the bottom of the vertical shaft.

The electricity produced by the generators is sent back up the stabilizing rods 25 to the electric motors 30 or some other use.

Once flywheel/generator assembly 14 reaches the bottom of flywheel path 38, clutches 19 are disengaged, and flywheel/generator assembly 14 is winched back up to the top of the shaft using the geared stabilizing rods 25 and the electric motors 30.

If necessary or desirable, electricity from a collocated additional energy source 36 can be used to lift flywheel/generator assembly 14 back to top of the flywheel path 38 using the geared stabilizing rods 25 which are attached to the stators on the generators 24 and run through the electric motors 30 on top of the housing 12. The lift is timed so as to maximize efficiency. Thereafter, the process is repeated.

The electrical energy generated by axle-mounted generator 24 on flywheel/generator assembly 14 can be used to assist in lifting flywheel/generator assembly 14 back to the top or can be used to enhance generation of electricity periodically in times of greatest demand or can be stored in some other system.

In another example and to demonstrate that the disclosed invention is not limited to a flywheel path in a triangular configuration, or in a zig-zag pattern, if we assume that the flywheel path is in the form of a straight shaft (as in FIGS. 5, 6 and 7) with the shaft being 1 m in length from top to bottom, thus forming a straight shaft as the flywheel path; and if we further assume that the small gear or sprocket has a diameter of 3 cm; and we further assume that the flywheel is designed in an efficient form with the majority of the mass on the outside edge of the flywheel and the flywheel has a diameter of 2.5 meters, with a mass of the entire flywheel assembly 14 of 500 kg, then we can mathematically determine the energy that can be produced, lost and/or stored by one cycling of the invention as follows:

To find how many rotations the small gear will make to travel 3 meters, we can follow these steps:
I. Calculate how many rotations the flywheel assembly will make to get to the bottom of the flywheel path

Since the teeth of the small gear or sprocket are engaged with the teeth on the rack or ring gear, and the flywheel is not connected to anything except the axle at its center, the number of rotations the flywheel assembly will take to get to the end of the flywheel path is governed by the circumference of the small gear or sprocket which are engaged with the teeth of the rack or ring gear.

### Step 1: Calculate the Circumference of the Small Gear or Sprocket.

The circumference of the small gear or sprocket is given by the formula:

$$C = π D$$

Where D is the diameter of the small gear or sprocket. Since the diameter of the small gear or sprocket is 3 cm, and x is 3.1416

$$C = 3.1 \; 416 \times 3 cm$$

$$3.1416 \times 3 cm = 9.4248 cm$$

So, the circumference of the small gear or sprocket is approximately 9.42 centimeters.

### Step 2: Convert the Distance to Centimeters

$$1 meters = 100 centimeters .$$

### Step 3: Find the Number of Rotations

To find the number of rotations, divide the total distance the gear travels (in centimeters) by the circumference of the gear.

$$Number of rotations = 100 cm / 9.42 cm = 10.61$$

Final Answer to Question No. I:

The flywheel assembly as it travels down the 1-meter-long flywheel path, from the top of the path to the bottom of the path, will rotate approximately 10.61 times, always in the same direction, and end at the bottom of the 1 meter run, the flywheel assembly will be 1 meter below where it started from. This calculation tells us that, with the clutches engaged, both the small gear, and the much larger flywheel, both of which are firmly attached to each other by the engaged clutches and the axle, will make 10.61 rotations to make the 1-meter trip down the flywheel path.
II. How many rotations will the flywheel assembly make if permitted to rotate freely for about 40% of the distance down the flywheel path before a load is put on the generators to try and bring it to a stop before it reaches the bottom?

In order to efficiently utilize the device, the flywheel assembly must be permitted to rotate freely for some distance so as to take advantage of the principals unique to gravity. By way of example, if we were to assume that we could permit the flywheel assembly to freely rotate as it rolled down the flywheel path for a distance of approximately 40 percent (40 cm) of the entire downward path before placing a load on the generators, then we could see how much kinetic energy had been stored in the flywheel at that particular point in time, that could then be harvested by the generators for the remaining 60 cm of the flywheel path.

The first step in this process is to determine how many rotations the flywheel assembly will make by the time it has traveled 40 cm. Since the small gear or sprocket teeth are engaged with the rack or ring gears and the flywheel is not connected to anything except the axle at its center, the number of rotations is governed by the diameter of the small gear or sprocket, not by the diameter of the flywheel.

To determine how many rotations a small gear or sprocket with a diameter of 3 cm will make to travel 40 cm, we follow these steps:

### Step 1: Calculate the Circumference of the Small Gear or Sprocket

$$C = 3. 1 \; 416 \times 3 cm$$

$$3.1416 \times 3 cm = 9.4248 cm$$

### Step 2: Calculate the Number of Rotations Needed to Travel 40 cm.

$$Number of rotations = total distance divided by the circumference of the small gear$$

$$Number of rotations = 40 / 9.42 = 4.24$$

Final Answer to Question No. II:

The flywheel assembly will make approximately 4.24 rotations to travel 40 cm down the flywheel path.
III. How much kinetic energy will be generated by the flywheel with a mass of the flywheel assembly of 500 kg and a flywheel diameter of 2.5 m rolling down a 90° slope, without slipping, for a total of 4.24 rotations?

If the straight shaft is completely vertical, then the slope of the shaft will be 90 degrees. To determine the energy generated by the flywheel rolling down a 90° slope without slipping, we need to take into account both the translational and rotational kinetic energy of the flywheel, as it is rolling (not sliding). When a rolling object moves without slipping, its motion is a combination of both translational (linear) and rotational kinetic energy.

### Given:

Mass of the flywheel assembly, m=500 kg
Diameter of the flywheel, D=2.5 m, so the radius R=D/2=1.25 m
Slope angle, 0=90° · Rotations down the slope, N=4.24
Acceleration due to gravity, g=9.81 m/s²

### Step 1. Distance Traveled by the Flywheel:

Each rotation of the flywheel corresponds to a distance equal to the circumference of the flywheel:

$$Circumference = 2 π R = 2 π \times 1.25 = 7.8 \; 54 m$$

The total distance traveled along the slope for 4.24 rotations is:

$$Total distance = N \times Circumference = 4.24 \times 7.854 = 33.3 m$$

### Step 2. Height Change:

Since the slope is a 90-degree incline, the total vertical height h descended by the flywheel is equal to the distance traveled along the slope:

$$h = 33.3 m$$

### Step 3. Potential Energy Lost:

The total gravitational potential energy lost as the flywheel moves down the slope is:

$$PE = mgh$$

$$PE = 500 kg \times 9.81 m / {s}^{2} \times 33.3 m$$

$$PE = 500 \times 9.81 \times 33.3 = 163 , 336 J$$

### Step 4. Energy Distribution:

For an object rolling without slipping, the total energy is divided into two components:
Translational kinetic energy (Ktrans)
Rotational kinetic energy (Krot)

The total kinetic energy is the sum of these two components:

$$Ktotal = Ktrans + Krot$$

Final Answer to Question No. III:

The energy generated by the flywheel assembly 14 as it rolls down the 90° slope for a total of 4.24 rotations is equal to the total potential energy lost, which is approximately 163,336 Joules (J). This energy is split between the translational and rotational kinetic energy as the flywheel moves down the slope.
IV. How long do the generators have, once a load is placed on them, to bring the rotating flywheel assembly to a stop?

The Generators now have 6.37 rotations of the flywheel assembly (10.61 rotations for the entire downward flywheel path, minus 4.24 rotations already traveled by the flywheel assembly before a load was placed on the generators) within which to harvest, electronically, the kinetic energy amassed in the flywheel assembly and bring it to stop. This rate will be governed by the size and capacity of the generators, and the rate at which they are permitted to bleed off energy.
V. How Much Energy will be needed to lift the Flywheel Assembly Back to the Top of the Flywheel Path where it started.

At this point in the process, the kinetic energy has been harvested by the generators, and the flywheel assembly has been brought to a stop at the bottom of the flywheel path. The question then becomes, “How much energy will be needed to lift the entire flywheel assembly back to the top of the flywheel path where the process can be repeated. The difference between the two will demonstrate how much energy has been lost, stored or generated in the process.

Since the lift is a vertical dead lift, neither the diameter of the flywheel nor the diameter of the small gear or sprocket are relevant, only the mass of the flywheel assembly. So, the question is how much energy is needed to lift 500 kg 1 meter.

To calculate the energy needed to lift a 500 kg object by 1 meter, use the formula for Work:

$$W = F \times d$$

### Where:

W is the work done (in Joules).
F is the force required to lift the mass (in Newtons)
d is the distance over which the force is applied (in meters)

### Step by Step Calculation:

$$F = m \times g$$

### Where:

m=500 kg is the mass
g=9.81 m/s² is the acceleration due to gravity

$$F = 500 kg \times 9.81 m / {s}^{2} = 4905 N$$

Now, using the formula for work:

$$W = F \times d = 4905 N \times 1 m = 4905 J$$

Final Answer to Question No. V.

The energy required to lift a 500 kg object by 1 meter is 4,905 joules (J).

### VI. The Net Result

Potential Energy generated by flywheel assembly=163,336 J
Minus the energy required to lift flywheel back to the top=4,905 J 163,336 J-4,905 J=158,431 J

In this example, the mathematical calculations demonstrate that in one cycling of the present invention in the assumed configuration, a net energy gain of 158,431 joules of energy are produced.

Different types of electrical generators (hydroelectric, nuclear, wind, solar, etc.) have different conversion rates, with hydroelectric being high [85%-95%] and wind turbines being low [35%-45%]). In all likelihood, due to the direct conversion of the potential energy from the mechanical energy of the flywheel into electrical energy, the conversion rate will be 90% or greater.

In any event, should the amount of energy needed to raise the flywheel assembly 1 meter back to its original starting position be more than generated through a cycle, the collocated alternative or conventional energy source can be utilized to effectuate or complete the lift.

### Circular Embodiment

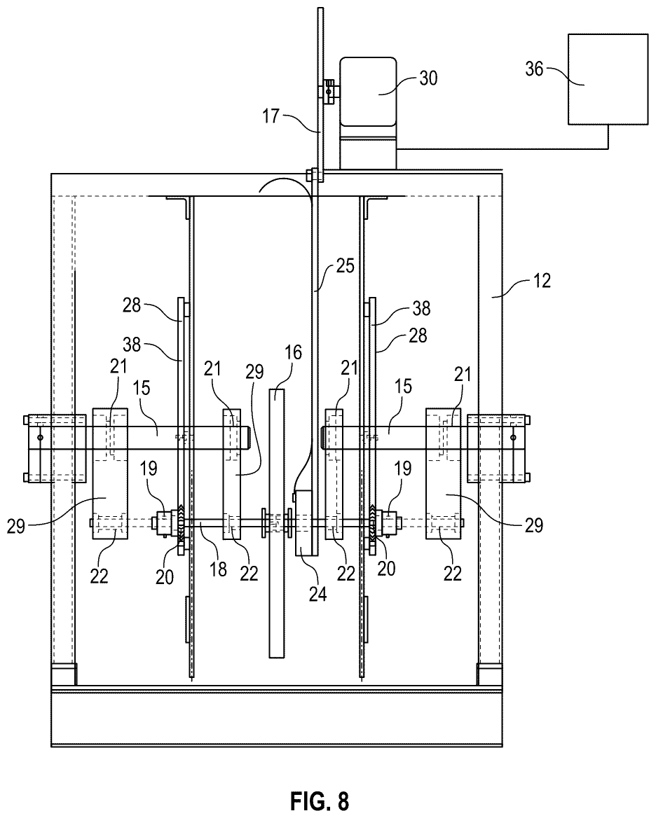

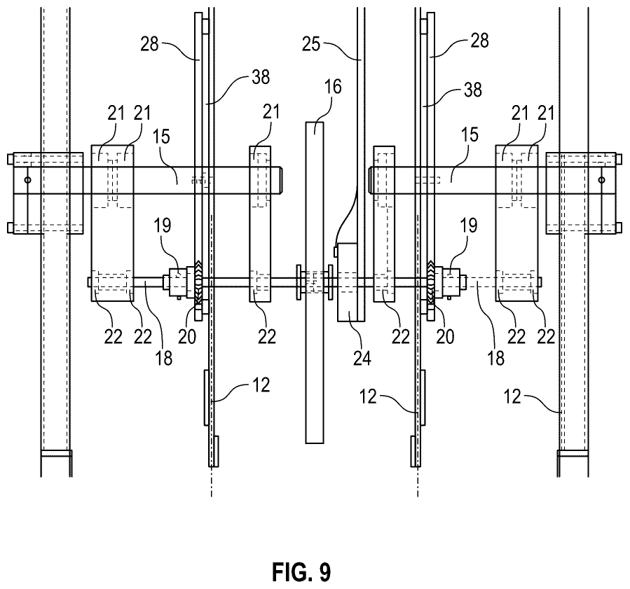

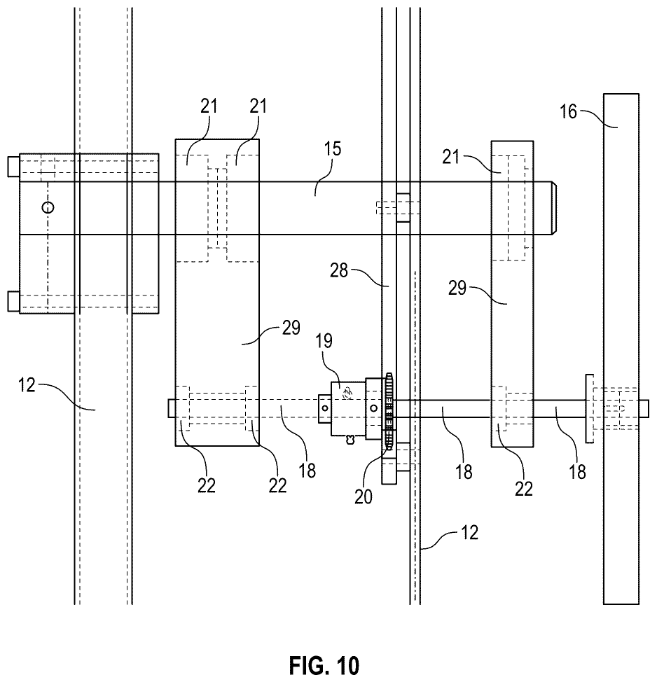

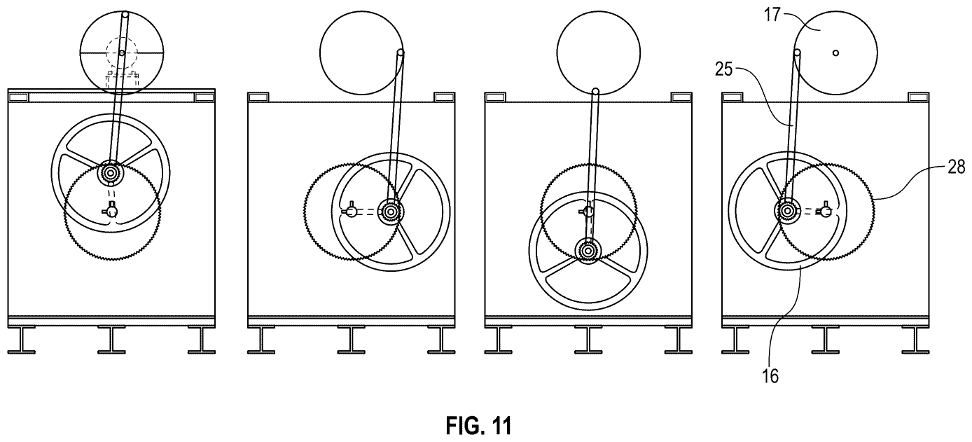

Now referring to FIG. 8, FIG. 9, FIG. 10 and FIG. 11, the operation of the flywheel assembly and hoist mechanism 10 in another embodiment (Circular configuration with center-line shaft and support arms) is described.

FIG. 8 shows a schematic diagram (side view) of a flywheel/generator assembly inside a housing in accordance with one exemplary embodiment of the present invention (a circular embodiment). In FIG. 8, the flywheel assembly is at the bottom of the flywheel path 38, or at the 6 o'clock position. It should be understood that in the circular embodiment, the flywheel path 38 is circular, defined by the ring gears 28, the support arms 29 and the center-line axles 15 that are firmly affixed to the housing 12. In the circular embodiment, since there are positions along the top of the flywheel path in which there is no bearing race can serve as a supporting structure upon which the flywheel assembly can rest, it must be held in place by other supporting structures. In addition, certain changes in the design of the flywheel assembly are necessary to accommodate those changes. In the circular embodiment, the flywheel assembly 14 is supported by center-line shafts 15 fixed in place to the housing 12. The center-line shafts 15 are connected to support arms 29 by one-way bearings 21 and in turn are connected to the flywheel assembly 14 by additional bearings 22 on the opposite end of the support arms 29. The bearings 22 are connected to the flywheel assembly axle 18 which in turn are affixed to the electric one-way clutches 19 the small gears or sprockets 20 the flywheel 16, and the axle-mounted computer-controlled generators 24. The small gears or sprockets 20 which are periodically engaged and disengaged by the electric one-way clutches 19 are constantly in contact with the ring gears 28 which in this configuration is in the geometric shape of a circle. Also shown in FIG. 8 is the stabilizing rod 25 which is connected to the stator on the generator 24 on one end and the other end of the stabilizing rod 25 is connected to a rotating disc 17 connected to the electric motor 30 on top of the housing 12. The rotating disc 17 is the same diameter as the flywheel path 38. FIG. 9 is a blowup of the flywheel assembly 14 inside the housing in an

exemplary circular embodiment which shows in greater detail the housing 12, the centerline axle 15, the one-way bearings 21, the support arms 29, the standard bearings 22, the axle 18, the electric one-way clutches 19 the small gears 20 the ring gears 28, the flywheel path 38, the flywheel 16 the axle-mounted computer-controlled generator 24 and the stabilizing rod 25. In FIG. 9 the flywheel assembly 14 is at the bottom of the flywheel path 38 or the 6 o'clock position. Not shown in FIG. 9 are the rotating disc 17 or the motor 30.

FIG. 10 is an even greater blowup of the flywheel assembly 14 inside the housing 12 in an exemplary circular embodiment which shows in greater detail the housing 12, one centerline axle 15, the one-way bearings 21, the support arms 29, the standard bearings 22, the axle 18, one of the two electric one-way clutches 19 one of the two small gears 20 one of the two ring gears 28, the flywheel path 38, and the flywheel 16. In FIG. 10 the flywheel assembly 14 is at the bottom of the flywheel path 38 or the 6 o'clock position. Not shown in FIG. 10 are the axle-mounted computer-controlled generator 24, the stabilizing rod 25, the rotating disc 17 or the motor 30.

In FIG. 11, flywheel assembly and hoist mechanism 10 is started with the flywheel/generator assembly 14 raised to the top (12 o'clock position as shown in first drawing on FIG. 11) of the flywheel/generator assembly path i.e., flywheel path 38. It should be understood that flywheel path 38 is defined by ring gears 28 and support arms 29 mounted with one-way bearings 21 to center-line shafts 15. With clutches 19 engaged, and axle-mounted computer-controlled generator 24 disengaged and not pulling any load, the flywheel/generator assembly 14 is released at 1 or more degrees past vertical in a clockwise direction as shown on the first drawing on FIG. 11 and gravity begins pulling the mass of flywheel/generator assembly 14 down flywheel path 38 in the clockwise direction as shown in the second drawing on FIG. 11. Immediately, gears or sprockets 20 which are engaged with the flywheel/generator assembly axle 18 by electric clutches 19, engage with ring gear assemblies 28 which are rigidly affixed in a circular pattern to housing 12, causing the small gears 20 to rotate counterclockwise as shown in FIG. 11. Since ring gear assemblies 28 are fixed in place and cannot move, and flywheel/generator assembly 14 floats within its bearings 22, the entire flywheel/generator assembly 14, except the stators on the outside of the generators 24 which are prevented from rotating by the stabilizing rods 25, begins to rotate as it descends. As flywheel/generator assembly 14 continues its descent down flywheel path 38, due to the quadratic nature of gravity, flywheel/generator assembly 14 increases in speed, quadratically, both translationally and rotationally. Not shown in FIG. 11 are the collocated conventional or other energy sources 36.

In this circular configuration, the stabilizing rods 25 are connected to the stators on the generators 24 on one end, and to a rotating disc 17 that is the same diameter as the ring gears 28 and are affixed to electric motors 30 on top of the housing 12 on the other end. In the circular configuration, the stabilizing rods 25 serve a dual purpose of preventing the stators of the generators 24 from rotating with the rest of the flywheel assembly 14, and can also be used, in connection with the rotating disc 17 connected to the electric motor 30 to lift the flywheel assembly 14 once the generators have brought the flywheel assembly 14 to a stop.

Since flywheel path 38 (in this example) is designed in the shape of a circle, the linear distance traveled by the flywheel/generator assembly 14 to get to the bottom is exactly the same distance it must travel to get back to the top.

At some point down flywheel path 38, a load is placed on axle-mounted computer-controlled generator 24. The load on axle-mounted computer-controlled generator 24 is calculated so as to extract the maximum kinetic energy stored in flywheel/generator assembly 14 slowly bringing it to a stop, both rotationally and linearly, by the time it reaches the bottom of the flywheel path 38.

The electricity produced by the generators is sent back up the stabilizing rods 25 to the electric motor 30 or some other use.

Once flywheel/generator assembly 14 reaches the bottom of flywheel path 38, at the 6 o'clock position as shown on the third drawing on FIG. 11, clutches 19 are disengaged, and the one-way bearings 21 which connect the support arms 29 to the center-line shafts 15 prevent the flywheel assembly 14 from swinging back in the opposite direction.

The flywheel/generator assembly 14 is then hoisted back up to the top of the circular flywheel path 38, as shown in the fourth drawing on FIG. 11, using the stabilizing rods 25, circular disc 17, and the electric motor 30.

If necessary or desirable, electricity from a collocated additional energy source 36 (shown in FIG. 8 but not shown in FIG. 9, FIG. 10, or FIG. 11) can be used to lift flywheel/generator assembly 14 back to top of the flywheel path 38 using the stabilizing rods 25 which are attached to the stators on the generators 24 and connected to the circular discs 17 and electric motors 30 on top of the housing 12. The lift is timed so as to maximize efficiency. Thereafter, the process is repeated.

The excess electrical energy generated by axle-mounted generator 24 on flywheel/generator assembly 14 can be used to assist in lifting flywheel/generator assembly 14 back to the top or can be used to enhance generation of electricity periodically in times of greatest demand or can be stored in some other system.

In another example and to demonstrate that the disclosed invention is not limited to a flywheel path in either a triangular configuration, a zig-zag pattern, or a straight shaft configuration, if we assume that the flywheel path is in the form of a circle (as in FIG. 8, FIG. 9, FIG. 10 and FIG. 11) with the diameter of the circle being 1 m in diameter as defined by the ring gears and the support arms which form the flywheel path; and if we further assume that the small gear or sprocket has a diameter of 3 cm; and we further assume that the flywheel is designed in an efficient form with the majority of the mass on the outside edge of the flywheel and the flywheel has a diameter of 2.5 meters, with a mass of the entire flywheel assembly 14 of 500 kg, then we can mathematically determine the energy that can be produced, lost and/or stored by one cycling of the invention as follows:
I. Calculate how many rotations the flywheel assembly will make to get to the bottom of the flywheel path

Since the teeth of the small gear or sprocket are engaged with the teeth on the ring gear, and the flywheel is not connected to anything except the axle at its center, the number of rotations the flywheel assembly will take to get to the end of the flywheel path (one circumnavigation of the ring gear) is governed by the circumference of the small gears which are engaged with the teeth of the ring gear.

### Step 1: Calculate the Circumference of the Small Gear or Sprocket.

The circumference of the small gear is given by the formula:

$$C = π D$$

Where D is the diameter of the small gear or sprocket. Since the diameter of the small gear or sprocket is 3 cm, and x is 3.1416

$$\begin{matrix}C = 3.1416 \times 3 cm \\ 3.1416 \times 3 cm = 9.4248 cm\end{matrix}$$

So, the circumference of the small gear or sprocket is approximately 9.42 centimeters.
Step 2: Determine the Distance of the Flywheel Path (i.e. The Circumference of the Ring Gear).

$$C = π D$$

Where D is the diameter of the ring gear. Since the diameter of the ring gear is 100 cm, and x is 3.1416

$$\begin{matrix}C = 3.1416 \times 100 cm \\ 3.1416 \times 100 cm = 314.16 cm\end{matrix}$$

So, the distance of the total flywheel path is 314.16 centimeters.

### Step 3: Find the Number of Rotations to Travel the Entire Flywheel Path

To find the number of rotations to travel the entire flywheel path, divide the total distance the gear travels (in centimeters) by the circumference of the gear.

$$Number of rotations = 314.16 cm / 9.42 cm = 33.33$$

Final Answer to Question No. I:

The flywheel assembly as it travels the entire distance of the circular flywheel path that is 1 meter in diameter, from the 12 o'clock position all the way back around and back to the 12 o'clock position, will rotate approximately 33.33 times. This calculation tells us that, with the clutches engaged, both the small gear, and the much larger flywheel, both of which are firmly attached to each other by the engaged clutches and the axle, will make 33.33 rotations to make one round trip around the 1 meter diameter flywheel path.
II. How many rotations will the flywheel assembly make if permitted to rotate freely for about 25% of the distance of the flywheel path (50% of the downward path from the 12 o'clock position to the 3 o'clock position) before a load is put on the generators to try and bring it to a stop?

In order to efficiently utilize the device, the flywheel assembly must be permitted to rotate freely for some distance so as to take advantage of the principles unique to gravity. By way of example, if we were to assume that we could permit the flywheel assembly to freely rotate as it rolled down the flywheel path for a distance of approximately 25% percent of the entire flywheel path (50% of the downward path from the 12o'clock position to the 3 o'clock position) before placing a load on the generators, then we could see how much kinetic energy had been stored in the flywheel at that particular point in time, that could then be harvested by the generators.

The first step in this process is to determine how many rotations the flywheel assembly will make by the time it has traveled from the 12 o'clock position to the 3 o'clock position. Since the small gear or sprocket teeth are engaged with the ring gears and the flywheel is not connected to anything except the axle at its center, the number of rotations is governed by the diameter of the small gear or sprocket, not by the diameter of the flywheel.

To determine how many rotations a small gear or sprocket with a diameter of 3 cm will make to travel 25% of the entire flywheel path, we simply multiply the number of rotations to make one circumnavigation of the ring gears by 0.25.

$$33.33 \times 0.25 = 8.33$$

Final Answer to Question No. II:

The flywheel assembly will make approximately 8.33 rotations to travel 25% of the distance around the circular flywheel path.
III. Since the flywheel path is in the form of a circle, and the descending slope from the 12 o'clock position to the 3 o'clock position is constantly changing, what angle should be used in the mathematical calculations to determine the slope for a 25% travel calculation?

The average of the angles from the 12 o'clock position to the 3 o'clock position is 45 degrees.

Final Answer to Question No. III:

The correct slope angle to use in the calculations to determine potential kinetic energy amassed in the flywheel as it travels from the 12 o'clock position to the 3 o'clock position is 45 degrees.
IV. How much kinetic energy will be generated by the flywheel with a mass of the flywheel assembly of 500 kg and a flywheel diameter of 2.5 m rolling down a 45° slope, without slipping, for a total of 8.33 rotations?

To determine the energy generated by the flywheel rolling down a 45° slope without slipping, we need to take into account both the translational and rotational kinetic energy of the flywheel, as it is rolling (not sliding). When a rolling object moves without slipping, its motion is a combination of both translational (linear) and rotational kinetic energy.

### Given:

Mass of the flywheel assembly, m=500 kg.
Diameter of the flywheel, D=2.5 m, so the radius R=D/2=1.25 m
Slope angle, 0=450
Rotations down the slope, N=8.33
Acceleration due to gravity, g=9.81 m/s²

### 1. Distance Traveled by the Flywheel:

Each rotation of the flywheel corresponds to a distance equal to the circumference of the flywheel:

$$Circumference = 2 π R = 2 π \times 1.25 = 7.854 m$$

The total distance traveled along the slope for 13.33 rotations is:

$$Total Distance = N \times Circumference = 8.33 \times 7.854 = 65.47 m$$

### 2. Height Change:

The height change, h, from the slope can be determined using the angle θ and the distance traveled along the slope:

$$\begin{matrix}h = Total distance \times sin ( θ ) \\ h = 65.47 \times sin ( 45 ∘ ) = 65.47 \times 0.707 = 46.28 m \\ h = 46.28 m\end{matrix}$$

### 3. Potential Energy Lost:

The total gravitational potential energy lost as the flywheel moves down the slope is:

$$\begin{matrix}PE = mg h \\ PE = 500 kg \times 9.81 m / {s}^{2} \times 46.28 m \\ PE = 500 \times 9.81 \times 46.28 = 227 , 003 J\end{matrix}$$

### 4. Energy Distribution:

For an object rolling without slipping, the total energy is divided into two components:
Translational kinetic energy (Ktrans)
Rotational kinetic energy (Krot)

The total kinetic energy is the sum of these two components:

$$Ktotal = Ktrans + Krot$$

Final Answer to Question No. IV:

The energy generated by the flywheel assembly 14 as it rolls down the 45° slope for a total of 8.33 rotations is equal to the total potential energy lost, which is approximately 227,000 Joules (J). This energy is split between the translational and rotational kinetic energy as the flywheel moves down the slope.
V. How long do the generators have, once a load is placed on them, to bring the rotating flywheel assembly to a stop?

Since the invention in in a circular configuration and since the device in this embodiment is equipped with one-way bearings between the support arms and the center-line axles, once the flywheel assembly has past the 6 o'clock position, it will begin to lose translational energy because past this point gravity will begin to work against it. However, to the extent it has swung past the 6 o'clock position due to centripetal acceleration, and back some distance up the flywheel path, it will remain in that position due to the action of the one-way bearings connecting the center-line axle to the support arms which prevent the flywheel axle from swing back the other way. It will continue to rotate in that position until all rotational kinetic energy has been consumed and converted to electricity by the generators.
VI. How Much Energy will be needed to lift the Flywheel Assembly Back to the Top of the Flywheel Path where it started.

At this point in the process, the kinetic energy has been harvested by the generators, and the flywheel assembly has been brought to a stop at the bottom of the flywheel path. The question then becomes, “How much energy will be needed to lift the entire flywheel assembly back to the top of the flywheel path where the process can be repeated. The difference between the two will demonstrate how much energy has been lost, stored or generated in the process.

Since the lift is a vertical dead lift, neither the diameter of the flywheel nor the diameter of the small gear or sprocket are relevant, only the mass of the flywheel assembly. So, the question is how much energy is needed to lift 500 kg 1 meter.

To calculate the energy needed to lift a 500 kg object by 1 meter, use the formula for-Work:

$$W = F \times d$$

### Where:

W is the work done (in Joules).
F is the force required to lift the mass (in Newtons)
d is the distance over which the force is applied (in meters)

### Step by Step Calculation:

$$F = m \times g$$

### Where:

m=500 kg is the mass
g=9.81 m/s² is the acceleration due to gravity

$$F = 500 kg \times 9.81 m / {s}^{2} = 4905 N$$

Now, using the formula for work:

$$W = F \times d = 4905 N \times 1 m = 4905 J$$

Final to Question No. VI.

The energy required to lift a 500 kg object by 1 meter is 4,905 joules (J). The lift may be somewhat less thatn that depending upon how high the pendulum has swung in the upward direction due to centripetal acceleration, and then held there by the one-way bearings between the support arms and the center-line shafts.

### VII. The Net Result

Potential Energy generated by flywheel assembly (assuming the generators bring it to a stop both translationally and rotationally at the 6 o'clock position=227,003 J Minus the energy required to lift flywheel back to the top=4,905 J 227,003 J-4,905 J=222,098 J

In this example, the mathematical calculations demonstrate that in one cycling of the present invention in the assumed configuration, a net energy gain of 222,098 joules of energy are produced.

Different types of electrical generators (hydroelectric, nuclear, wind, solar, etc.) have different conversion rates, with hydroelectric being high [85%-95%] and wind turbines being low [35%-45%]). In all likelihood, due to the direct conversion of the potential energy from the mechanical energy of the flywheel into electrical energy, the conversion rate will be 90% or greater.

In any event, should the amount of energy needed to raise the flywheel assembly 1 meter back to its original starting position be more than generated through a cycle, the collocated alternative or conventional energy source can be utilized to effectuate or complete the lift.

### Properties Common to all Configurations

The flywheel assembly and hoist mechanism utilizes the flywheel as an accumulator of gravitational forces, that accumulates the dynamic nature of gravity acting on a falling body quadratically, as opposed to traditional uses of gravity to power and/or store electricity which only use gravity in its static form, i.e. on a body at rest, which is limited to its mass, and has no quadratic acceleration properties.

The excess electrical energy generated by axle-mounted generator 24 on flywheel/generator assembly 14 can be used to assist in lifting flywheel/generator assembly 14 back to the top or can be used to enhance generation of electricity periodically in times of greatest demand or can be stored in some other system.

It is important that the diameter of flywheel 16 is always larger than the diameter of the gears or sprockets 20. This difference in the diameters of small gear or sprocket 20 and the much larger diameter flywheel 16 create both the speed and the torque in flywheel 16 that are necessary to make the invention efficient. Further, a person skilled in the art understands that flywheel 16 rotates due to accumulation of gravitational force, and the quadratic acceleration force caused due to its construction and produces energy required to generate electricity. Further, a person skilled in the art understands that a flywheel larger in diameter but weighing the same as a smaller diameter flywheel will produce much more torque to turn an electric generator than the smaller diameter flywheel, even though the energy needed to lift the two flywheels is identical.

A person skilled in the art understands that permitting the device to rotate freely for a portion of time before placing a load on the generators permits the device to harvest the properties of gravity as it acts on a falling body quadratically, instead of the traditional uses of gravity to harvest energy which were limited to the use of gravity's static properties, i.e. the weight or mass of an object unaffected by acceleration.

Since the force of flywheel 16 increases by the square of the rotational speed of flywheel 16, and only linearly with the mass of flywheel 16, the more rotations it takes to get to the end of rack and/or ring gear assemblies 28 and the greater the diameter of flywheel 16, the greater the ability of flywheel 16 to store enough energy to power axle-mounted computer-controlled generators 24. Furthermore, since the flywheel has the ability to rapidly deploy the stored energy within it, the rapid expression of the stored energy can be used as needs occur.

It is useful to express, the capability of flywheel 16, in terms of time absorbed by the flywheel to get to the bottom of flywheel path 38 as well as the diameter of flywheel 16 itself, as the kinetic energy collected by the flywheel scales with the square of speed rather than mass. Furthermore, gravity's effect also squares with time. As a result, a larger (greater diameter) flywheel 16 being spun on a smaller diameter gear or sprocket 20 produces much more torque in order to efficiently drive a generator back up to the top.

The presently disclosed flywheel/generator assembly utilizes the flywheel to act as an accumulator of gravitational forces, and the quadratic acceleration unique to gravity to power electric generators and/or alternators. Since gravity is one of the driving forces of the flywheel, it is available 24 hours a day, 365 days a year and is available geographically everywhere. In addition, it is not hazardous to the environment.

In order to increase efficiency, mechanical bearings 22 can be replaced with magnetic bearings, and mechanical sprockets or gears 20 and rack and ring gear assemblies 28 can be replaced with magnetic gear assemblies/combinations which would greatly reduce the harmful effect of friction. In addition, the system could be run in a vacuum which would also increase efficiency by reducing friction on the flywheel assembly 14.

### Advantages Over the Prior Art

The presently disclosed flywheel assembly and hoist mechanism provides several advantages over the prior art. The flywheel assembly and hoist mechanism utilizes the flywheel as an accumulator of gravitational forces, that accumulates the dynamic nature of gravity acting on a falling body quadratically, as opposed to traditional uses of gravity to power and store electricity which only use gravity in its static form, I.e. on a body at rest, which is limited to its mass, and has no quadratic acceleration properties.

The accumulation and storage of the kinetic energy in the flywheel permits the device to store and rapidly release kinetic energy allowing for highly efficient energy conversion. The flywheel assembly and hoist mechanism allows the entire flywheel/generator assembly to rotate as it descends down the flywheel path, due to the quadratic nature of gravity. This results in the flywheel/generator assembly to increase speed, quadratically, both linearly and rotationally. The flywheel assembly and hoist mechanism presents a quadratic increase in rotational speed as the flywheel descends the flywheel path which maximizes the energy density. This enables the flywheel assembly and hoist mechanism to generate significant amounts of electricity from a relatively compact design.

Further, the flywheel assembly and hoist mechanism combines certain features of the gravitational energy storage system (GESS) with certain features of the flywheel energy storage system (FESS) to maximize efficiencies.

The fact that the flywheel assembly and hoist mechanism, in part, utilizes gravity to accumulate and store energy, it is available in abundance with no fuel cost, and is available at any location either above ground or below ground, and can even be utilized in abandoned structures such as old factories or warehouses.

The fact that the flywheel assembly and hoist mechanism can be combined with other collocated energy sources and utilizes gravity, permits it to function at practically any location, whether urban or rural permits the production and storage of energy to be decentralized, and thereby avoid widespread power outages, both manmade and natural.

The manufacture of most embodiments of the flywheel assembly and hoist mechanism systems are relatively inexpensive as compared with alternative energy sources, and do not require complicated machining processes, and can even be constructed using off-the-shelf parts that are readily available. By way of example, the one-way electric clutches are currently available off the shelf, an example of which are those manufactured by McMaster-Carr Through Shaft Electric One-Way Clutches. Likewise, an example of the one-way bearings are those manufactured by VXB Ball Bearings NSSS50 One Way bearings.

A person skilled in the art appreciates that the flywheel assembly and hoist mechanism can come in a variety of shapes and sizes depending on the need and comfort of the user. Further, many changes in the design and placement of components may take place without deviating from the scope of the presently disclosed flywheel assembly and hoist mechanism.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

### Advantages and Disadvantages of Different Embodiments

The triangular shaped embodiment has as an advantage over other embodiments the fact that it can be designed so that the linear path down is longer than the linear path up. In addition, it does not subject the small gears to the same stress forces as the other embodiment. In addition, the triangular shaped embodiment can be stacked one upon another as in the zig-zag pattern. The major disadvantage it has that the other embodiments do not have is that it requires the flywheel assembly to make dramatic turns as it descends, which subject it to g-forces and stresses not experienced by the other embodiments.

The straight shaft embodiment has advantages over the other embodiments in that it is simpler to design, construct, and operate. What's more, it can probably be cycled many more times an hour than other embodiments.

The Circular embodiment has advantages over the others in that it takes advantage of centripetal acceleration and is not subject to radical turns or abrupt movements. However it is more difficult to manufacture.

What is claimed is:

1. A flywheel assembly and hoist mechanism for powering at least one electric generator, said flywheel assembly and hoist mechanism comprising:
a housing;
a flywheel assembly positioned in said housing, said flywheel assembly comprising:
a flywheel;
an axle connected to said flywheel;
sprockets or gears mounted on said axle;
clutches mounted on said axle;
bearings supporting said flywheel on said axle; and
at least one electric generator mounted on said axle;
a computer-controlled load management system connected to said at least one electric generator;
a stabilizing rod connected to at least one stator on one electric generator;
a flywheel path defined for said flywheel assembly in said housing, wherein said flywheel path comprises a configuration in which flywheel assembly can be returned to its point of origin by the hoist mechanism, and wherein said flywheel path comprises rack and/or ring gear assemblies;
at least one pivoting sleeve or other fixed structure through which the stabilizing rod can run to stabilize the stator,
a hoist mechanism aligned with said flywheel path, and
wherein said flywheel assembly positions at the top of said flywheel path, wherein said sprockets or gears engage with said rack and ring gear assemblies and engage with said clutches causing said flywheel assembly to rotate and travel down said flywheel path, wherein said stabilizing rod prevents the stator from rotating with the rest of the flywheel assembly, wherein said flywheel stores kinetic energy with each rotation of said flywheel assembly and said kinetic energy is converted into electricity by said at least one electric generator, and wherein said hoist mechanism receives said axle of said flywheel assembly at the bottom of said flywheel path and lifts said flywheel assembly back to the top of said flywheel path.

2. The flywheel assembly and hoist mechanism of claim 1, wherein said rack and ring gear assemblies are mounted along a downward flywheel path of said flywheel path to create and maintain rotational motion of said flywheel assembly as it spins always in the same direction.

3. The flywheel assembly and hoist mechanism of claim 1, wherein the diameter of said flywheel is larger than the diameter of said sprockets or gears.

4. The flywheel assembly and hoist mechanism of claim 1, wherein said flywheel assembly and hoist mechanism maximizes the efficiency by combining a gravitational energy storage system (GESS) and a flywheel energy storage system (FESS).

5. The flywheel assembly and hoist mechanism of claim 1, wherein the stator of at least one generator is prevented from rotating with the rest of the flywheel assembly by at least one stabilizing rod affixed to the stator on one end and passing through a pivoting yet firmly affixed sleeve in the housing or lifting motor.

6. The flywheel assembly and hoist mechanism of claim 1, wherein the rotation of said flywheel assembly increases quadratically as it travels down said flywheel path, storing kinetic energy in said flywheel.

7. The flywheel assembly and hoist mechanism of claim 1, wherein a load is placed on said at least one electric generator with said computer-controlled load management system during a downward travel of said flywheel assembly to extract the maximum kinetic energy stored in said flywheel and to slowly bring it to a stop, both rationally and linearly, by the time said flywheel assembly reaches the bottom of said flywheel path.

8. The flywheel assembly and hoist mechanism of claim 1, further comprises an auxiliary electrical source to power said hoist mechanism to lift said flywheel assembly back to the top of said flywheel path.

9. The flywheel assembly and hoist mechanism of claim 1, wherein said flywheel assembly travels longer in a downward path of said flywheel path than the distance said flywheel assembly travels vertically via said hoist mechanism to get back to the top of said flywheel path.

10. The flywheel assembly and hoist mechanism of claim 1, wherein said flywheel operates as an accumulator of gravitational and quadratic acceleration forces to power said at least one electric generator.

11. The flywheel assembly and hoist mechanism of claim 1, wherein said flywheel assembly comprises bearing races, and wherein said bearings and said bearing races configure to secure said flywheel to said axle while allowing said flywheel assembly to float and rotate freely within said flywheel path.

12. The flywheel assembly and hoist mechanism of claim 1, wherein said hoist mechanism comprises an electric winch or motor connecting to a hoist catch cradle via a cable, or other lifting device and wherein said hoist catch cradle or other lifting device receives said axle of said flywheel assembly and lifts said flywheel assembly back to the top of said flywheel path.

13. The flywheel assembly and hoist mechanism of claim 1, wherein the speed of said flywheel's rotation and its linear motion are governed by varying loads placed on said at least one electric generator.

14. A flywheel assembly and hoist mechanism for powering at least one electric generator, said flywheel assembly and hoist mechanism comprising:
a housing;
a flywheel assembly positioned in said housing;
a flywheel path defined for said flywheel assembly in said housing, wherein said flywheel path comprises a configuration in which the flywheel assembly can be returned to its original point of origin by the hoist mechanism; and
a hoist mechanism aligned with said flywheel path,
wherein said flywheel assembly positions at the top of said flywheel path and rotates along a downward path of said flywheel path, wherein said flywheel assembly stores kinetic energy and converts into electricity with each rotation, and wherein said hoist mechanism receives said flywheel assembly and lifts said flywheel assembly back to the top of said flywheel path.

15. The flywheel assembly and hoist mechanism of claim 14, wherein said flywheel assembly comprises:
a flywheel;
an axle connected to said flywheel;
sprockets or gears mounted on said axle;
clutches mounted on said axle;
bearings supporting said flywheel on said axle; and
at least one electric generator mounted on said axle;
at least one stabilizing rod attached on one end to the stator on at least one generator while the other end passes through a pivoting, yet fixed sleeve or motor in the housing.

16. The flywheel assembly and hoist mechanism of claim 14, wherein said flywheel assembly comprises a flywheel, an axle connected to said flywheel, sprockets or gears mounted on said axle, clutches mounted on said axle, at least one electric generator mounted on said axle and at least one stabilizing rod attached on one end to the stator on at least one generator while the other end passes through a pivoting, yet firmly affixed sleeve or motor in the housing,
wherein said flywheel path comprises rack and ring gear assemblies, wherein said rack and ring gear assemblies are mounted along said downward flywheel path to create and maintain rotational motion of said flywheel assembly as it spins always in the same direction, and wherein said sprockets or gears engage with said rack and ring gear assemblies causing said flywheel assembly to rotate along said flywheel path.

17. The flywheel assembly and hoist mechanism of claim 14, wherein the rotation of said flywheel assembly increases quadratically as it travels down said flywheel path, storing kinetic energy in said flywheel.

18. The flywheel assembly and hoist mechanism of claim 14, wherein said flywheel assembly travels a longer linear distance on said downward path than the distance said flywheel assembly travels a linear distance vertically using said hoist mechanism to get back to the top of said flywheel path.

19. The flywheel assembly and hoist mechanism of claim 14, wherein the system is run in a vacuum.

20. The flywheel assembly and hoist mechanism of claim 14, wherein the mechanical bearings and gears are replaced with magnetic bearings and gears.

21. A method of providing a flywheel assembly and hoist mechanism for powering at least one electric generator, said method comprising the steps of:
providing a housing;
providing a flywheel assembly positioned in said housing, said flywheel assembly comprising a flywheel, an axle connected to said flywheel, sprockets or gears mounted on said axle, clutches mounted on said axle, bearings supporting said flywheel on said axle, at least one electric generator mounted on said axle, and at least one stabilizing rod attached on one end to at least one stator in one generator while the other end passes through a pivoting, yet fixed sleeve in the housing;
defining a flywheel path for said flywheel assembly in said housing, said flywheel path being configured in a configuration in which the flywheel assembly can be returned to its point of origin by the hoist assembly;
providing rack and ring gear assemblies along said flywheel path;
providing a hoist mechanism aligned with said flywheel path;
positioning said flywheel assembly at the top of said flywheel path;
releasing said flywheel assembly to travel down said flywheel path by engaging said sprockets or gears with said rack and ring gear assemblies to cause said flywheel assembly to rotate and allowing said flywheel to store kinetic energy with each rotation for electricity generation;
receiving said axle of said flywheel assembly at said hoist mechanism; and
lifting said flywheel assembly back to the top of said flywheel path.

22. The method of claim 21, further comprising configuring said flywheel assembly to travel longer in a downward path of said flywheel path than the distance said flywheel assembly travels vertically using said hoist mechanism to get back to the top of said flywheel path.
